(19) United States
(12) Patent Application Publication
(10) Pub. No.: US 2017/0164597 A1
(43) Pub. Date: Jun. 15, 2017

(54) IMPROVED TERMITE MONITORING AND CONTROL APPARATUS AND METHODS OF USING SAME

(71) Applicant: PEST IP PTY LIMITED, New South Wales (AU)

(72) Inventors: Peter Alexander Brown, New South Wales (AU); Garry Joseph James Ryan, New South Wales (AU)

(21) Appl. No.: 15/301,841

(22) PCT Filed: Apr. 2, 2015
(86) PCT No.: PCT/AU2015/000199

§ 371 Date: Oct. 4, 2016

(30) Foreign Application Priority Data
Jul. 4, 2014 (AU) 2014901248
Oct. 20, 2014 (AU) 2014904179
Oct. 21, 2014 (AU) 2014904202
Dec. 5, 2014 (AU) 2014904920

(51) Int. Cl. A01M 1/02; A01M 1/20

(52) U.S. Cl. CPC A01M 1/026; A01M 1/2011; A01M 2200/011; G08B 21/18

(57) ABSTRACT

An improved termite monitoring and detection system which in the preferred form utilises a first bulk attractant and a second smaller portion of attractant, whereupon consumption of the smaller portion activates a short travel biased trigger mechanism to create a detection signal without disturbing the termites as they continue to consume the bulk attractant. A variety of electronic and electrical features are optionally included which facilitate remote monitoring, optional remote application of termiticide and multi-party interfacing. The system also enables third party bulk collection of termite activity data and provides a system which ensures compliance with agreed monitoring and treatment protocols.

### FIELD OF THE INVENTION

The present inventions relate to improved termite detection and monitoring devices or stations, and associated systems for both monitoring and, optionally, eradicating termites once their presence is confirmed. The devices and systems have been developed in various embodiments to be particularly suited to either the existing professional pest control or the DIY market. However, the invention also proposes systems that facilitate interaction with an intermediary organisation which can operate to monitor and validate the actions of end user customers and/or professional field operators, and/or collect valuable data in relation to termite activity, treatment effectiveness, and other useful related variables.

### BACKGROUND TO THE INVENTION

Any discussion of the prior art throughout the specification should in no way be considered as an admission that such prior art is widely known or forms part of common general knowledge in the field.

There are few reliable and proven methods to ascertain whether termites are present, other than to manually and periodically inspect timber or other attractants for direct evidence of infestation, visually inspect for termite mud trails, or scan for their heat signature.

A commonly used method involves the use of monitoring stations, bait stations or inspection stations, which are located on ground or in ground in areas where termites may be present or may pass by. These stations include some form of attractant to entice the termites into the station through openings, after which they consume the attractant and congregate in the containers. The theory then is that stations can be manually inspected so the presence of the termites can be observed. Once detected, slow acting targeted non-repellent or edible materials that include chemicals or agents to gradually disable termites can be added to the stations. These are what are referred to as bait, or a termiticide that is consumed, which is picked up by the termites in the stations and then transported back to the main nest where the entire colony is ideally eradicated.

Termiticides can operate in different ways by, for example, affecting the ability of the termites to reproduce, affecting their ability to shed their outer layers (moult), or by disrupting their brain behaviour which can, for example, affect the ability of the termites to eat.

Some work only on the worker termites, thereby starving a colony when the workers are all killed, and others operate to kill all the termites including the soldier termites and the queen. Regardless of the mechanism by which the termiticide works, the aim is to use a termiticide which works slowly enough to ensure that the worker termites make it back to the nest with the termiticide to eradicate a majority of them there, but quickly enough to cease their consumption activity before too much other local damage can be done.

However, with existing termite stations, this theoretical operation is generally thwarted by problems inherent in the current designs and in the systems and processes relating to the monitoring procedures. For example, in most cases, the station housings have openings in the portions of the walls to be placed in contact with, or buried in, the ground. The stations are then inspected by removing a lid or cap device and looking inside the station from the top. Firstly, particularly if the openings extend up the side walls, if slugs, slaters, worms, ants etc., and/or dirt from the surrounding environment have entered the station, which is a common occurrence, the station top openings have to be manually cleared before a visual inspection can be made. Not only is this time consuming and unreliable, the action of simply removing the lid, let alone physically clearing out any living or inert contamination, will cause a change in atmospheric conditions to which termites are sensitive. This is very likely to cause the termites to leave if present at that time. Once this happens, any opportunity to continue to use the station as a means to then apply the termiticide for conveyance of a sufficient quantity back to the nest to destroy them at source, has then been lost.

A range of devices have been proposed that include some form of spring biased physical indicator system, where the spring is retained in an activated position by either an edible retaining rod or strap, or a block of bait that prevents the spring from returning to it's rest position and thereby activating the indicator system until the bait or attractant has been consumed. However, in all these devices the dramatic movement of the indicator mechanism after activation by the termites will likely cause them to leave and be deterred from returning for ongoing monitoring and treatment.

In other solutions stations are pre-loaded with a bait that includes a termiticide. However this has limitations, as it may start killing off the worker termites before a regular feeding pattern from the colony is established in connection with that source. This may reduce the chance of the full colony being eradicated, and/or require that only very slow acting termiticides be used, meaning it may take years for the colony to be destroyed.

In addition, termiticide has a very limited effective life once it has been exposed. Accordingly, there is the additional very real risk that by the time the termites visit a station pre-loaded with bait, the termiticide component may have become inactive.

Furthermore, to date these systems have focused on external ground based stations and there do not appear to have been any systems proposed for identifying and monitoring the presence of termites within a building structure. In this regard, if an external physical termite barrier in a building is breached, the ability of termites to consume cellulose based elements internally, without compromising the outer surface and/or structural integrity of those elements during the consumption phase, means that when they are finally detected, extensive damage will most likely already have been done.

Additionally, the current systems do not provide the customer with any means of involvement with, or validation and assurance of, systems installed and monitored by pest control companies. Further, currently available DIY systems rely on periodic manual inspection, which if too infrequent, may mean potentially damaging delays in detection, or undetected full consumption of the attractant materials rendering the station useless at that stage. The chances of successful eradication after detection may also be compromised by the disturbance effects of physical intervention discussed above.

Currently, there is also very little data available to validate current detection and eradication methods and/or determine how currently or historically prone a particular geographical region may be to termite activity.

It is an object of the present invention to overcome or ameliorate one or more of the disadvantages of the prior art, or to provide a useful alternative.

### SUMMARY OF THE INVENTION

According to a first aspect of the invention, there is provided a termite detection apparatus including a housing defining:

a first chamber for receiving and retaining a quantity of termite attractant, the first chamber having at least one external wall portion, at least one opening via which termites can enter and leave the first chamber to access the attractant, and at least one internal wall portion having a transparent viewing section, and

a second inspection chamber co-extending with said first chamber, the second chamber including an openable second chamber lid portion and generally inperforate walls, wherein at least one wall portion of the second chamber is defined by at least a part of the transparent internal wall portion of said first chamber.

In this manner, the contents of the first chamber can be observed and monitored via the second chamber, using appropriate optical scopes as needed, without disturbing the atmospheric conditions or contents within the first chamber.

In most preferred forms the first chamber also includes a removable or openable lid portion to close off the chamber but enable periodic access for maintenance or replenishment of attractant and/or application of termiticide or bait etc.

Preferably the termite access opening in the first chamber is adjacent to and may include the base of the chamber. In another embodiment, the first chamber may include a series of apertures in the wall portion via which termites may enter the first chamber.

In a preferred form configured to be buried in the ground, the housing is preferably generally elongate in peripheral shape, and ideally is generally cylindrical to facilitate easy installation using an auger or similar hole digging tool. However, in other forms it can be prismatic with a plurality of flat sides or indeed any convenient shape.

In one particularly preferred form, the external housing is generally tubular or cylindrical and the first and second chambers are delineated by means of an internal wall member that extends internally along the vertical extent of the cylinder to intersect the outer cylindrical housing walls at two peripherally spaced locations. In one form, two such internal wall members are provided that are parallel and spaced apart to thereby define a central first chamber with two second inspection chambers disposed one on each side. The internal wall member or members may be fully transparent or include one or more transparent panels therein.

In other embodiments, the first and second chambers are delineated by means of an internal wall member or members that extends internally along the vertical extent of the cylinder and which do not contact the outer housing walls. For example, the internal dividing wall may comprise a tubular formation that could be positioned concentric to, or offset from, the external housing.

In one range of embodiments, the apparatus is designed to enable a “flat pack” transportation mode, with a view to assembly when needed. In one such embodiment the external housing is defined by a generally rectangular flexible panel which can be rolled and secured to form the cylindrical outer walls, with clip base and lid elements. This external panel will ideally only include perforations, if at all, in regions designed to form an external wall of the first chamber. More preferably these perforations will not be provided in the region adjacent the lid to prevent or reduce the chance of contamination via soil, slugs, worms or similar. In the most preferred forms, access by the termites is restricted to entry from an opening in the base of the first chamber. In another flat pack form, the cylinder outer walls are made from two longitudinal half cylinder portions, preferably interconnected by a live hinge type connection.

In the preferred flat pack embodiments the internal dividing walls delineating the first and second chambers are ideally in the form of more rigid, generally inperforate, at least partially transparent rectangular panels designed to slide into the formed housing cylinder, acting to simultaneously provide bracing for the housing as a whole.

In some embodiments a clip in base is also provided which may also include perforations in a region aligned with the first chamber for access by the termites. The lid elements for each of the first and second chambers may be independently operable and the second chamber lid portions will ideally be hinged to allow easy opening for inspection. A further external weatherproofing cap may also be provided in some embodiments to keep dirt away from the opening lid portions of the apparatus, protect them from manmade damage, from the UV of the sun, and help prevent water ingress into the device through these top openings.

In some forms, the first chamber will be configured to hold the attractant an offset distance from the base. This helps to reduce the chance of attractant deteriorating when buried and makes it easier to detect the termites which will likely build a mud bridge up from base which will be easier to see via the inspection chambers than if the termites enter straight into the attractant from the base. Optionally, the means to support the attractant may be deliberately non-rigid, to further encourage the termites to shore up the attractant prior to consumption.

Desirably, the apparatus of the first aspect of the invention optionally includes an inspection tool to enable viewing of the first chamber via insertion of the tool into the adjacent inspection chamber(s) to view the attractant through the transparent wall portion there between. This tool may include a simple wand, mirror and light arrangement or a more complex fibre optic scope or camera or any other suitable device.

The attractant may comprise a selected hardwood or softwood, manufactured cellulose fibre based attractant or a combination of these or any other material that will operate to attract termites into the apparatus. In one preferred form a combination of hardwood and softwoods are used to attract all types of termites and not just those attracted to one type or the other.

Desirably, the attractant may be comprised of multiple materials, with preferentially enticing material being disposed adjacent the transparent wall portion such that termite presence is clearly visible via the inspection chamber as early as possible.

Optionally, termiticide loaded bait elements may also be added to the system as needed. In one form, bait sticks specifically configured for sliding into the inspection chamber via the top inspection lid opening have been proposed. Ideally these bait sticks have longitudinally extending flutes or corrugations to maximise surface area for a given volume to maximise termiticide transfer to the termites. Preferably the flutes are sized to provide pathways for the termites to/from a portion of the bait stick. In such embodiments one or more openings need to be provided within the inspection chamber for access by the termites. This opening may be provided in the internal wall portion separating the first and second chambers.

According to a second aspect of the invention, there is provided a termite detection apparatus including a housing for receiving and retaining a termite attractant, the housing including at least one opening via which termites can enter and leave the housing to access the attractant, the housing further including detection and alarm means which detects the presence of termites and optionally triggers an associated alarm indicia.

The detection means may include a moisture and/or movement sensor responsive to the increased humidity and/or motion generated by the presence of termites. Alternatively, the detection means may include sensors responsive to temperature cycle variations caused by termite presence, or weight variations caused by termite presence and/or any weight variation in the system and/or the attractant resulting from the presence of termites and/or their consumption of the attractant.

In yet another form the detection means may respond to predetermined noise signals generated by the termites. In a preferred form, the noise signal may be that generated by the termites banging their bodies against the surrounds when agitated by an appropriately threatening stimulus which may be an artificially created input noise or vibration.

The alarm indicia responsive to an output from the detection means may be visual, electronic, auditory or any other suitable form.

In one form, the detection means comprises a physical mechanism is configured to generate physical movement of a trigger element once at least a portion of the attractant is consumed or otherwise contaminated by termite entry into the housing. More preferably, the mechanism is one which is biased into an activated alarm position, but retained in a deactivated position by a connection that will be compromised by the presence of termites.

More specifically, the retention in a deactivated position is preferably achieved by use of a pre-tensioned tensile tie, which when broken or disconnected from an anchor point allows the mechanism to return under a biasing force to the activated position thereby activating the alarm signal.

Preferably non consumable forms of tensile ties are constructed from a material to which mud created by the termites will not adhere in a structural manner. One such preferred material is stainless steel wire.

Accordingly, in a preferred form of the second aspect of the invention there is provided a termite detection apparatus including a housing defining:

a first chamber for receiving a first bulk portion of termite attractant and a second smaller portion of attractant;

a small movement trigger and a first switch operable by the trigger, the trigger including means to bias it into an activated position whereby it operates the first switch;

anchor means disposed within the second smaller portion of attractant and connected with the trigger via a tensile tie to hold the trigger against the biasing force into a deactivated position;

at least one gate opening via which termites can enter and leave the housing to initially access only the second portion of attractant;

wherein the materials of the second attractant are selected so as to be consumed in the presence of termites to cause disconnection of the tensile tie between the anchor means in the second portion of attractant and the trigger to thereby operate the switch while facilitating ongoing consumption of the first bulk portion of attractant.

The term “small movement” is intended to refer to a movement that in use, depending on the configuration of the trigger and the rest of the system, is unlikely to startle the termites sufficiently to cause them to vacate the apparatus. Examples of acceptable movement ranges may include up to around 4 mm.

In some forms, the anchor means and/or the tensile tie and/or tie to anchor means connection are made from a consumable attractant. Additionally, the tie element and/or connection between the tie element and the anchor means, may also be configured to weaken in the presence of moisture or increased humidity as occurs in the presence of termites.

Preferably, the tie is connected with the attractant via a configuration that enables some degree of control of the time frame in which the connection is compromised and the detection alarm is activated.

In one form the anchor means includes an element of attractant configured to act as a counterweight that is suspended from the tie element.

In some forms, the first chamber is fully open at the base and the bulk of the attractant, which could be in the form of a counterweight or free or supported block, is preferably sized and shaped to fit closely to the shape of the chamber so as to discourage termites or other pests such as slugs and insects from entering and contaminating the chamber.

In one preferred form, the anchor means is in the form of a hook type element which is embedded with the material of the second portion of attractant, such that on consumption of the attractant material around the hook formation, the hook is released thereby releasing tension from the tensile tie such that a biasing force is free to act on the trigger and activate an alarm signal.

The first attractant portion is represented by a larger bulk portion of attractant material that will likely be consumed by the termites after the second portion has been substantially consumed. In this manner the termites will be directed to consume the second preferential plug material portion prior to commencing consumption of the remaining first bulk portion of attractant and so trigger an alert at an early stage.

In one form where the anchor means is in the form of a counterweight of first bulk portion attractant and, the small second portion of preferentially enticing attractant is embedded within the first portion bulk form of attractant, with both combining to form the counterweight.

In another form, the small second portion of preferentially enticing attractant forms the anchor means and is physically restrained from movement within the first chamber, and the first bulk portion of attractant is entirely separate.

In another preferred form, the only entry to the first chamber is via a small entry gate in the housing that leads to the second portion of attractant to ensure this is consumed first and the trigger is activated. Non-termite pests cannot then enter the main chamber. Ideally there are very small drainage holes in the base. In other embodiments where the second portion of attractant is located within the first bulk portion, the exposed surfaces of the bulk portion may be protected by a plastic film or similar so that it can only be accessed for consumption after the second portion has first been consumed.

In further enhancements to this embodiment, a PIR (Passive Infra-Red) sensor may be provided at or adjacent the gate to passively detect termites prior to the trigger being activated and confirm their continuing presence after the trigger has been activated. While preferred as an adjunct to other detection devices, it could also be used as a primary detection means which electronically triggers an associated alarm indicia.

In one form the first preferentially attractive second portion attractant material will be made of a soft and easily eaten material including sawdust or other particulate matter which can be moulded into formations in the housing or in the first bulk portion attractant as required. In many forms the first bulk portion attractant material may include a solid block of single type or multiple type wood materials.

Without relying on this hypothesis, it is believed that this anchor and tensile tie concept works with the strengths and habits of termites in relation to their ability to ensure against structural collapse when consuming wood based products or other attractants. Typically, on entering the apparatus and determining there is attractant worth consuming, the termites will immediately shore up the attractant with mud trails, particularly if it is made of wood or wood products, so that it is then stabilised and not likely to move. In this regard most termites do not like or tolerate much environmental movement, so this will likely be a priority.

Once the termites are satisfied with the structural integrity and stability of the environment, they proceed to consume the attractant, and in the process directly or indirectly compromise the connection between the tensile tie element and the counter weight or physical anchor on the housing, thereby releasing the restrained limited movement trigger into the activated position thereby signalling their presence. Direct compromising may be by means of consuming an attractant based adhesive connection point to the anchor, consuming the tie element itself which may also include attractant, or consuming the attractant, which could be separate from or form part of a counter weight, in the region of the connection with the tie element. Indirect compromising may be by means of an increased environment moisture content being caused by the presence of the termites causing a moisture sensitive tie element or connection to fail.

The fact that most of the bulk attractant material does not move once the connection is compromised due to being previously shored up by the termites, and the only movement is limited to that of the comparatively much smaller lighter tie element and the trigger, means that the termites are not unduly disturbed at the point the trigger is released, and so are not frightened into exiting the apparatus and moving elsewhere as would be the case in most prior art systems.

The moveable trigger element and indicator/alarm indicia can take any suitable form. For example in one embodiment, the trigger and indicator may include a mechanical element such as the lid portion of the first chamber, which is biased into a partially open position (sufficient to provide an indication of termite presence without unduly disturbing them) by means of a suitable resilient device such as a spring (compression, leaf or torsion) or an “o” ring gasket type arrangement or other means to apply a resilient biasing force. In another form, the lid itself does not move, but an appropriately biased protuberance or button type arrangement extends through the lid or indeed another portion of the housing.

While the movement of the trigger and associated lid, button, flag or similar element, may provide a visual indicator, the trigger could also, or instead, activate other forms of visual, auditory or other alarms including lights, buzzers, or electrical/electronic signals that could be monitored remotely via various suitable low energy wireless devices. The signals could be picked up and processed by any suitable device directly, or indirectly via a centralised hub system, including computers and mobile devices such as smart phones and tablets or any other existing or future technology adaptable to this use. These devices could receive messages from each monitoring station/device indicating a variety of data including battery energy, date and time of inspections, such as when either lid or lids are lifted or closed as well as information regarding whether termites have potentially been detected. Cameras, motion detectors, wi-fi chips and other potentially useful devices can be associated with the hub system to expand the overall functionality of the system and benefits to the user, extend beyond simply termite monitoring.

In another preferred variation of the second aspect of the invention, the apparatus includes means to automatically apply a termiticide to the first chamber once the termites are detected.

In one form, the failure of the tensile tie connection with the anchor means is also used, again via means of a pre-loaded biasing mechanism, to then directly or indirectly activate release of a set dose of termiticide. The mechanism can be integrated with, or separate from the mechanism activating the alarm trigger.

In one proposed form a pre-mixed termiticide reservoir in the form of a sealed pouch or capsule is provided within the portion of the housing in which the attractant is located and a puncturing device is provided on a pre-loaded biasing means, which is released when the tension is broken in the tie, and then moves to pierce the pouch or capsule and thereby automatically release the termiticide. In other embodiments the bait may be in a sealed wrapping that can be removed by the action of a motor and an induced weakness in the wrapping.

In other forms, the termiticide may be encapsulated in a bait material (a premix of attractant and suitable termiticide) in a form which can be released into the first chamber at a predetermined time when termites are indicated as being present. In one preferred form the bait is in the form of balls of bait material so as to be flowable on release from a sealed container where it is stored prior to be required.

In some embodiments, the reservoir is preferably located above the attractant at a location whereby it will be released on to the tie element which will act as conduit to deliver the termiticide down through the attractant to a position near the base where most of the termite activity is likely to be occurring.

In one form particularly designed for external use, the housing may additionally include some or all of the features of the apparatus according to the first aspect of the invention that includes one or more co-extending visual inspection chambers separated from the attractant by means of an at least partially transparent wall element, with or without the bait sticks previously described.

In accordance with a third aspect of the invention, there is provided a “smart” termite detection and treatment apparatus, the apparatus including:

a housing defining:

a first chamber for receiving and retaining a quantity of termite attractant, the first chamber having at least one opening via which termites can enter and leave the first chamber to access the attractant,

the first chamber further including transducer means for detecting the presence of termites according to predetermined variations in one or more properties of elements within the first chamber, and termiticide storage and dispensing means,

a control chamber housing communication means,

wherein signals from said transducer means in the first chamber are processed via the communication means which in turn directly or indirectly activates the dispensing means to deliver termiticide to the first chamber.

Preferably the dispensing means is configured to enable controlled release of the termiticide.

The transducer means can be a physical mechanism that activates an electronic switch, a temperature sensor, a weight sensor, a moisture sensor, an audio sensor, or any other suitable device that is configured to send a signal to the communication means either in the control chamber or in the first chamber.

The termiticide can also be in any suitable form including any one or more of the following:
Termiticide encapsulated in a sealed container of bait which is preferably in a flowable pellet form such that on receipt of a signal from the communication means a mechanism is operated to dispense the pellets into the first chamber;
Termiticide concentrate encapsulated in a sealed container which can be mixed with a stored volume of water to activate prior to dispensing into the first chamber; or
Termiticide concentrate encapsulated in a pressurised gas cartridge.

The dispensing and/or mixing means may be driven by a small electric motor, which by means of appropriate associated drive mechanisms, may operate to open bait or termiticide concentrate and/or water containers, mix as needed to activate, and open valves or gateways as needed to dispense into the first chamber.

In other embodiments, the termiticide may be encapsulated in a pressurised container of suitable gas which acts to preserve the active ingredients and provide the means to dispense them when required.

Preferably the communication means has a signature unique to each apparatus or station and is programmable to perform a number of functions which may include sending an output signal reporting activation of a termite detection signal to a user, pest controller or independent monitoring authority and receiving command signals from an external source to activate release of termiticide and optionally report on completion to the instructor or another identified party. The communication means may also monitor and report on battery condition, remaining shelf life of active ingredients etc. The communication means may also be configured to verify physical inspections by monitoring opening of inspection ports and/or replacement of consumables using electronically date coded packages of same and the like.

In accordance with another variation there is provided an apparatus according to the first, second or third aspect which is specifically configured for internal use to be built in, or retrofitted, at locations where termites are likely to transit if present, such as via bottom plates of timber frame structures and the like. For embodiments based on the first aspect which rely solely on visual inspection, the housing may include an access port for positioning on a wall or architrave or similar configured to enable viewing within the housing with a suitable viewing tool. For embodiments based on the second aspect of the invention, the trigger mechanism may be connected to a switch to activate an indicator light or similar positioned at a remote location or send a signal to a computer or smart phone device. Ideally these monitoring devices are positioned adjacent a location where there is an interface between multiple wood types in a structure such as near door frames, at the intersection of wall plates and vertical elements of a wall structure and the like, as these are particularly favoured by termites as paths through which they are not easily detected.

Other embodiments can incorporate the automated electronic detection methods of other embodiments described herein, and can form part of a full internal and external monitoring system.

The various embodiments described above are able to be incorporated into a system for facilitating termite monitoring and pest control of termites. Accordingly, in accordance with a fourth aspect of the invention there is provided a system for monitoring termites on a property, the system including:

one or more termite monitoring devices, each device having an electronic termite detection means for detecting the presence of termites and a transceiver configured to issue a detection signal in response to the detection of termites;

a central hub responsive to the detection signal for issuing alerts to one or more external parties regarding the presence of termites on the property.

The external parties preferably include a pest controller, an owner of the property, a manager of the property, an owner of the system or an administrator of the system.

The system preferably includes a database for storing information indicative of termite detection events.

The central hub preferably communicates with the external parties by way of a web server and associated web-based interface. In one embodiment the web-based interface includes a website renderable through a web browser software. In another embodiment the web-based interface includes a proprietary software application executable on a mobile device.

The one or more termite monitoring devices preferably include a termiticide release means for selectively releasing termiticide. In one embodiment the termiticide release means releases termiticide in response to the detection of the presence of termites by the termite detection means. In another embodiment the one or more termite monitoring devices are responsive to instruction signals from the external parties and the termiticide release means releases termiticide in response to a received instruction signal.

In accordance with a fifth aspect of the invention there is provided system for monitoring termites on a property, the system including:

one or more termite monitoring devices, each device having an electronic termite detection means for detecting the presence of termites and a transceiver configured to issue a detection signal in response to the detection of termites;

a remote server responsive to the detection signal for issuing alerts to one or more external parties regarding the presence of termites on the property.

In accordance with a sixth aspect of the invention there is provided a system and associated method for recording and certifying adhesion to a pest control protocol for a particular installation based on the steps of:

installing a plurality of termite monitoring devices each having a unique identification marker,

recording into a database data associated with each unique device within an installation,

associating said data with a pre-determined policing and reporting program;

generating policing reminders from the program specifying actions to be taken in relation to each unique device and feedback required; and

recording feedback from actions taken in response to the reminders.

The database can be maintained by any suitable party, which depending upon application may be a particular pest control company or a third party independent body in a “back to base” type configuration.

In preferred forms the termite monitoring and control devices will be smart devices in accordance with the third aspect of the invention. In this manner a back to base control system can be used to assure compliance, record outputs and inputs to the system and accumulate valuable data which may be useful in enhancing future systems and better understanding the behavious of termites generally as well as in a particular geographic location.

In most preferred forms the individual devices will be configured to communicate locally with a centralised hub system which then on communicates long distance to one or more relevant organisations such as those described herein.

The system may further include means within or separate to the policing program to compare the recorded feedback against a pre-set protocol of actions and outcomes and generate a report of compliance with the protocol.

Depending on the types of monitoring devices used, the system may record date of installation, replacement of attractant and/or batteries within set time frames, inspection frequency, proof of inspection including date of inspection, outcome of inspection, date of application of termiticide, etc.

The unique identification markers could be simple indicia like alphanumeric codes, bar codes, Q codes, RFIDs or indeed any means of applying a preferably unique identification, that for the more complex systems can ideally be read automatically using an appropriate scanning device.

Similarly, the policing reminders may be delivered to the stakeholders responsible for the installation, be that a pest control company or home owner, manually or automatically via internet or phone or other suitable means.

It will be appreciated that while the system will ideally use devices according to the first or second aspect of the invention, other devices could also be used.

When corporations or individuals sell monitoring stations to many installers of these systems, there is an advantage in unifying the benefits of the system by having either a single organisation who runs the computer server, that takes messages from each monitoring station and directs the outcome of these messages to those that would benefit from receiving either better interpreted data or instructions to proceed. An example may be that a property owner would receive feedback from monitoring events so that they could be kept informed of monitoring or indeed termite elimination progress. The property owner becomes involved in the system from an information technology perspective by the inclusion of data into a server that ties individual monitoring stations to a property and then to a contact person. There may be many computer servers operating separately from each other. To truly gather the significance of the data from every computer server their data could be aggregated by another organisation that for instance provides heat maps of termite activity in a region, so that interested parties may understand the concept of termite swarms, intensity of termite activity in a certain area or just make people aware of property damage potential in their area of concern.

In yet another range of embodiments, the presence of the termites can be triggered by movement of an element within the housing from an inherently unstable position to a stable position by action of the termites.

In one form, the bulk attractant may be configured to rest on a pivot point where the attractant is initially held in an inactivated position by weight balance, or assisted by light springs etc. The weight and shape can be configured such that the termites are directed to a particular region of the attractant, whereby once the weight of the attractant is reduced at that location, the balance is upset and the attractant tips to the stable position, at the same time activating some form of switch or alarm triggered directly or indirectly by the movement of the attractant mass or elements connected thereto.

In another variation, the unstable bulk attractant may be held in the initial inactivated position by a plug of preferentially enticing attractant, such that once this bracing element is consumed it ceases to support the mass attractant which then tips to the stable position as above.

### BRIEF DESCRIPTION OF THE DRAWINGS

Preferred embodiments of the invention will now be described, by way of example only, with reference to the following drawings in which:

FIG. 1 is a perspective view of a first embodiment termite detection apparatus according to a first aspect of the invention with the lid elements removed;

FIG. 2 is a cross-sectional view of the apparatus of FIG. 1 with lids installed illustrating use of a suitable inspection tool;

FIG. 3 is a cross sectional view of a removable domed cap for use optional use with the apparatus shown in FIGS. 1 and 2;

FIG. 4 is a cross-sectional view of a first embodiment detection apparatus according to a second aspect of the invention incorporating an automatic termite detection mechanism illustrated in the initial installation mode;

FIG. 5 is a cross-sectional view of the apparatus of FIG. 4 shown in the activated position after the likely presence of termites has been detected;

FIG. 6 is a cross-sectional part view of a second embodiment apparatus according to the second aspect of the invention having an alternative trigger and indicator arrangement which also incorporates a system for automatically releasing a termiticide when the presence of termites is detected, shown in the deactivated position at installation;

FIG. 7 is a cross-sectional part view of the apparatus of FIG. 6 shown in the activated position after the likely presence of termites has been detected;

FIG. 8 is a partly sectioned perspective view of a wall section incorporating a third embodiment apparatus according to the second aspect configured for internal use; and

FIG. 9 is a partly sectioned perspective view of a wall section incorporating a second embodiment apparatus according to the first aspect configured for internal use;

FIG. 10 is a perspective view of an alternative embodiment to that shown in FIGS. 4-7 wherein the counterweight is replaced by a trigger that is anchored to the housing remote from the bulk attractant;

FIG. 11 is a perspective view of the partion element of FIG. 10 illustrating further detail of the anchor and trigger arrangement;

FIG. 12 is a perspective view of the attractant plug for use in the embodiments of FIGS. 10 and 11;

FIG. 13 is a perspective view of a further embodiment with a termiticide tank and mixing and/dispensing mechanism;

FIG. 14 is a part view of the gate mechanism at the base of the tank of FIG. 13;

FIG. 15 is a perspective view showing an example that utilises a gas cartridge to dispense termiticide;

FIG. 16 is a perspective view of a further embodiment that detects termites by weight variation utilising attractant attached to a weigh chip;

FIG. 17 is a plan view of one suggested layout for the smart controls in the lid of various embodiments;

FIG. 18 is an exploded view of a sample circuit board shown in FIG. 17;

FIG. 19 is a schematic illustration of a system for facilitating pest monitoring and pest control;

FIG. 20 is a schematic system-level overview of the system of FIG. 19;

FIG. 21 is a process flow diagram illustrating the primary steps in an exemplary method of facilitating pest monitoring and control;

FIG. 22 is an information flow diagram showing exemplary information transfer between the various parties who use the system of FIGS. 19 and 20;

FIG. 23 is a process flow diagram outlining the primary steps in a method of recording and certifying adhesion to a pest control protocol;

FIG. 24 is a sketch of an embodiment based on the principle of an unstable weight moving to an equilibrium position after system is altered by termite activity; and

FIG. 25 is shows an example of a fluted bait stick configured for use in the inspection chamber of a dual chamber apparatus according to various aspects of the invention.

### PREFERRED EMBODIMENTS OF THE INVENTION

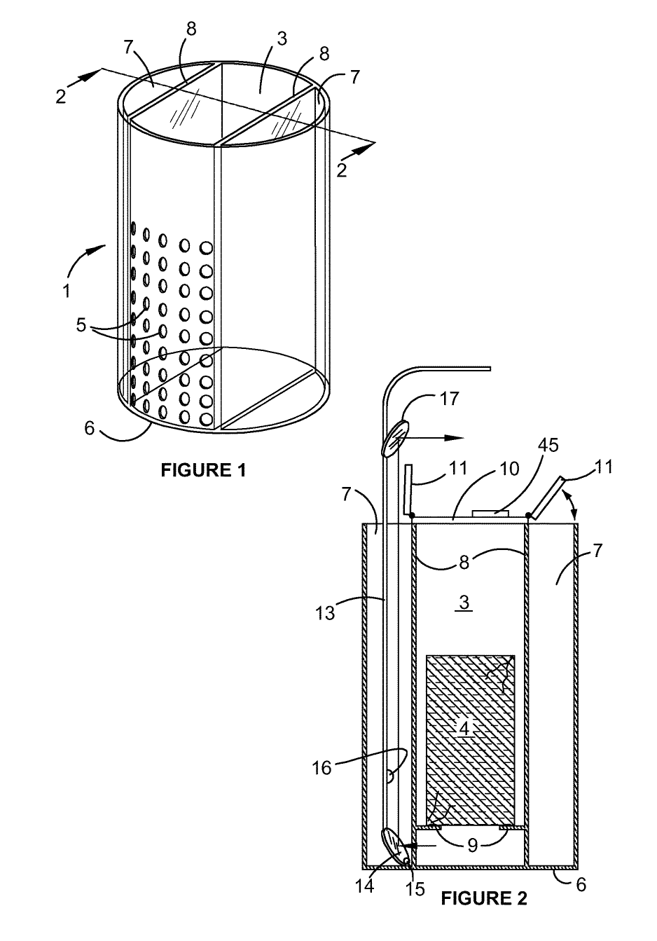

Referring firstly to FIGS. 1 and 2 there is shown a first embodiment termite detection apparatus 1 according to a first aspect of the invention. The apparatus includes a housing shown generally at 2 which defines, in this particular example, a single generally centrally disposed first chamber 3 for receiving a quantity of termite attractant represented by the block shown at item 4. As can be seen, the housing 2 includes a series of perforations 5 aligned with the first chamber 3, to enable access of the termites to the attractant 4. Similar such perforations may be provided in the base 6.

Flanking either side of the first chamber 3 are two second inspection chambers 7. The inspection chambers 7 are delineated from the first chamber 3 by means of the partition walls 8. These partition walls are at least partially transparent, particularly in a region adjacent the attractant 4. In the illustrated embodiment, the entire partition wall panels are transparent.

Ideally, the portions of the housing 2 defining the external sides of the inspection chambers 7 are imperforate to prevent ingress of dirt and the like to keep the inspection portions of the partition walls 8 clean for viewing. Additionally, in the preferred forms, the partition walls 8 may include protruding block support elements 9 which operate to hold and space the attractant 4 from the base 6.

In the illustrated embodiment, the apparatus includes a first lid 10 which covers the opening to the first chamber 3. This lid can be secured in any suitable manner and could be a push fit, or hinged as required. The function of this lid primarily is to protect the attractant and prevent ingressive water and dirt to the first chamber from above.

Each of the inspection chambers 7 also include independently operable lids 11. These lids serve to close and protect the inspection chambers 7 and provide access when required. In one preferred form they are hingedly connected with the housing via the partition walls 8 so they can be readily opened during the inspection process while still being retained to the apparatus to reduce the chance of becoming lost.

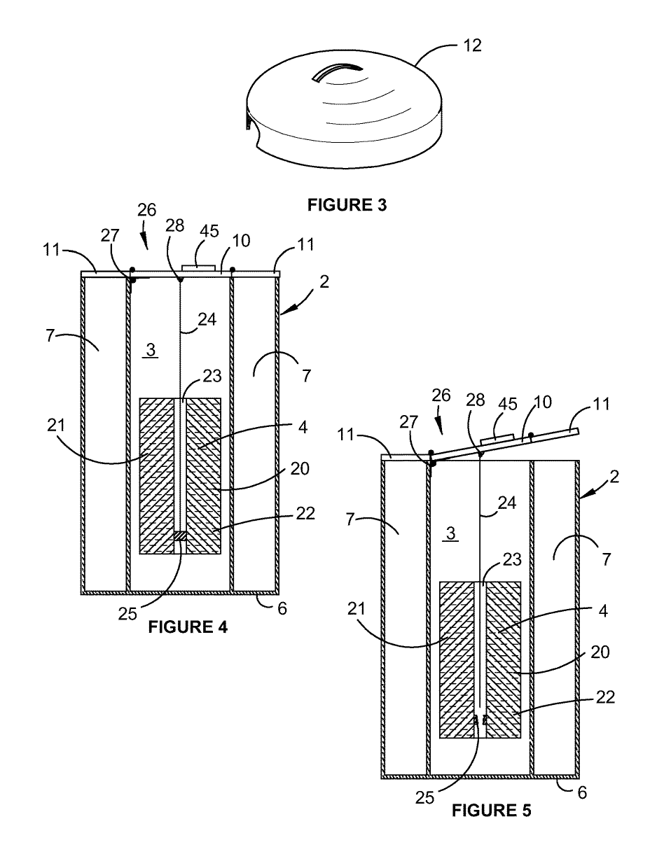

Optionally, a protective cap 12 as shown in FIG. 3 or similar may also be provided which extends over the underlying lids (10 and 11) to prevent water and dirt entering via the hinge arrangements and the like. If this cap is opaque it may be desirable to have some or all of the underlying lids 10 and 11 transparent to enable a first line of inspection without moving any element of the main apparatus.

Also illustrated in FIG. 2 is an example of a basic inspection tool 12 which includes an extension arm 13 incorporating a primary mirror element 14, ideally angled at approximately 45 degrees to the longitudinal extent of the extension arm 13, with an associated light source 15 or 16. Optionally, an additional angled mirror 17 is provided toward a handle end of the inspection arm as shown, although this is unlikely to be needed in most in ground applications unless there are obstacles obstructing direct downward viewing in to the device.

In one particularly preferred form, the various components of the housing are manufactured from polymeric materials that are provided in sheet form, which can then be punched out and formed into the product as shown. This enables “flat pack” packaging, which is highly desirable for optimising costs associated with assembly, transport, packaging costs and retail and warehousing shelf space etc.

In one currently preferred embodiment the diameter of the assembled station is approximately 90 mm in diameter. The length is preferably approximately 200 mm, and ideally configured for on-site shortening if needed in shallow soil and rocky ground types. Preferably the length of the attractant is approximately 100 mm although this is not important as long as ideally still works when device is shortened and provides an adequate quantity determined by the design.

In use, the apparatus is fully assembled and primed with an appropriate block of attractant 4. This attractant may be in the form of a particular wood, or a combination of different woods and/or various manufactured attractants as are readily available on the market.

Using an appropriate hole digging tool such as an auger, an appropriately sized hole is made in the grounds of the area to be monitored, which is usually in a garden surrounding a dwelling, and the assembled device is inserted such that the lid and cap region is installed to be approximately flush with the surface of the ground.

As with existing stations of a similar basic structure, the installed stations as they are known are then periodically inspected to determine if any termites are present.

Depending on the nature of the material selected for the lids 10 and 11 and the optional protection cap 12, inspection can be achieved in a variety of ways. Firstly, if a transparent lid 10 is used on the first chamber 3, it is possible that a first visual inspection will in fact identify termites within that chamber. If no termites are immediately observed, the next step is to conduct an inspection through the inspection chambers 7. This involves raising the lid on a first of the inspection chambers and looking into that chamber, most likely with the assistance of a suitable inspection tool 12 such as that shown in FIG. 2.

While the termites can enter chamber 3 via perforations 5 in either the housing side walls or the base 6, the fact that the attractant 4, in a preferred embodiment, is positioned a spaced distance from the base 6, makes it more likely to spot termites entering from the region of the base. Further, if the spacer elements 9 have some degree of resilience, such that the attractant is not rigidly located or sitting on a firm base, there is a good chance that the termites will first shore up the attractant with mud trails prior to consuming the attractant, again increasing the evidence of termite presence.

Referring next to FIG. 4, there is shown a cross-sectional view of a first embodiment of a termite detection apparatus 1 in accordance with the second aspect of the invention. As there are many elements of the second aspect that are common with that of the previously described embodiment of the first aspect of the invention, like reference numerals will be used to denote corresponding features.

The housing 2 shown in FIG. 4 may be cylindrical as in FIG. 1, which is useful for ease of installation for in-ground applications, or could be a rectilinear prism or any other suitable shape as may be more appropriate for internal use where the device may need to sit against building elements such as timber bottom plates, studs and architraves and the like, as will be discussed in more details at a later stage.

In the illustrated embodiment, it can be seen that the housing 2 incorporates the novel and inventive coextending inspection chambers 7 that flank the main chamber 3 in which the attractant 4 is based. However, while useful, it should be noted that this is not essential to the second aspect of the invention which operates on the principal of incorporating a termite sensitive mechanism that has a moveable trigger element that includes means to bias it into an activated position, which is then held during initial set up in a deactivated position by means of a counter weight connected with the trigger via a tensile tie. The aim being that when the connection between a trigger and the counter weight fails, the trigger is biased into its activated position thereby signalling a likely presence of termites.

In the embodiment illustrated in FIGS. 4 and 5, the counter weight 20 comprises a first bulk portion block of attractant 4, which in one preferred form as shown comprises a softwood element 21 and a hardwood element 22 ideally having a passage 23 into which the tensile tie element 24 can extend.

The tie element 24 can be connected to the counter weight 20 in a number of different ways but ideally by one which is frangible in the presence of termites.

In this particular embodiment, a smaller second portion of attractant is used in the form of an adhesive plug 25 is used to connect the tie 24 to the block 4 that ideally also includes preferential attractants likely to encourage the termites to consume the adhesive when, or preferably in advance of, consuming the attractant provided in the counter weight. Another means by which to improve the chances of reasonably early failure in the presence of termites, is to also use a tie that includes attractant. It will be appreciated that a non attractant counter weight could be used with an attractant based tie 24 and/or adhesive, or a simple wire tie with an attractant based counterweight or any other combination where the termites will be attracted into the chamber and cause the connection between the pre-loaded tie 24 and counter weight to fail as a result of their presence.

The other end of the tie element 24 is secured to the trigger mechanism shown generally at 26 which in this particular instance comprises the lid 10 which is biased into an open position, as shown in FIG. 5, by means of a torsion spring 27. The tie 24 is connected via a simple hook element 28, but numerous other types of connection could be used.

In this particular embodiment the torsion spring 27, which for stability is preferably a double paired torsion spring, also acts as a hinge for the lid 10. As it is desirable to configure the device to minimise movement of the lid 10 so an not to unduly disturb the termites (2-4 millimetres may be ideal), it may be preferable to have the lid configured to slide onto the spring arms, so that when it needs to be fully opened it can easily be removed and reattached. Alternatively, a separate hinge can be provided and the lid 10 configured to simply sit on the torsion spring 27. Once again a protective cap 12 may also be included of the kind illustrated in FIG. 3.

In use, the station is set up as shown in FIG. 4 with the counterweight applied to hold down the lid 10 against the biasing upward force of the torsion spring 27. Depending on the materials used, the entry of termites into chamber 3 will cause the connection of the tie element 24 with the counterweight to fail. This can happen by moisture from the termites affecting the adhesive element or the structural integrity of the tie element if appropriate materials are used, or by degradation via consumption of the adhesive 25, strap 24 and/or attractant 4 in the region of the connection 25.

In the illustrated embodiment, it can be seen from FIG. 5 that in this instance the connection has between the tie element 24 and counter weight 20 failed by deterioration of the adhesive plug 25 after consumption by the termites. This in turn has released the end of the tie 24, causing the lid 10 to pivot open as shown under the action of the torsion spring 27. The visual effect of this small movement could be enhanced, by, for example, having the peripheral edges of the lid 10 in a bright colour such as red which is easily seen once exposed.

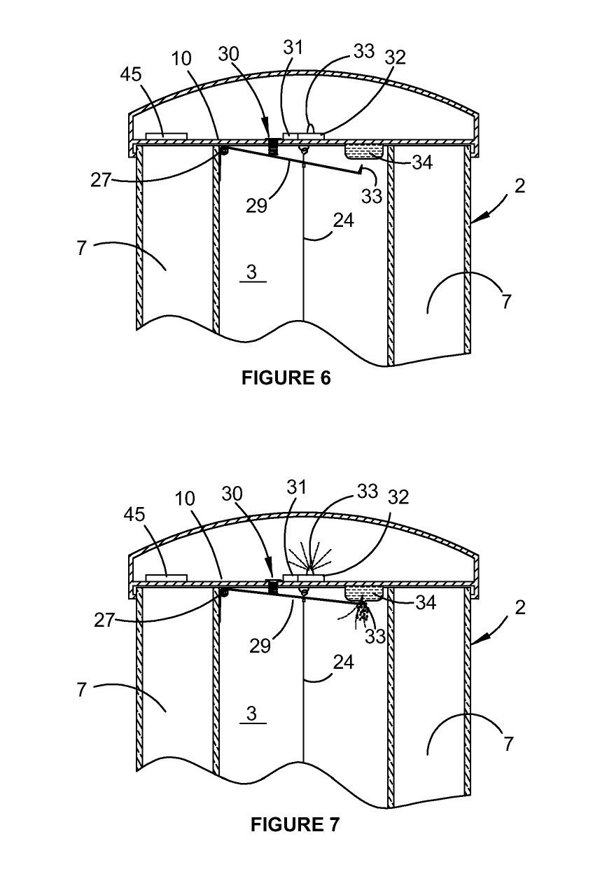

Referring next to FIGS. 6 and 7 there is illustrated sectional part views of an alternative trigger and indicator arrangement which also incorporates a system for automatically releasing a termiticide when the presence of termites is detected, shown firstly in the deactivated initial state and the activated state after the presence of termites has been detected. It will be appreciated that this dosing system is an optional feature, as a termitide could be included in the original attractant or added manually after detection. The termiticide dosing system illustrated could also be used with or without an automatic detection alarm indicator system such as that shown in FIGS. 1 and 2. Similarly, while inspection chambers are not illustrated so as to simply to drawing, it will of course be appreciated that these could be included if desirable.

As can be seen, the lid 10 this time is configured to remain stationary during activation of alarm trigger mechanism and the termiticide dosing system. Instead the resultant actions are caused directly by a trigger arm 29 that is connected to, or forms part of the resilient biasing means, which once again is a torsion spring 27. When set, this arm remains clear of the mechanisms associated with the lid as shown. However, once the tension in the tie 24 is broken, the trigger arm 29 springs upwardly toward the lid simultaneously pushing up a switch, which in this form is biased into an inoperative condition, which then works to operate a battery pack 31 and signal circuit 32 as shown in FIG. 7, setting off, in this instance, a flashing LED 33.

At the same time, the distal end of the trigger arm includes a piercing point 33 also moves upwardly to puncture a capsule or pod of termiticde 34 housed under the lid 10. Depending on the positioning of the capsule and the tie 24, the termiticide will then drop onto the counterweight and attractant ideally using the tie 24 to assist in directing the termiticide towards the base of the attractant to accelerate delivery to the termites likely to be in the base portion of the chamber. Accordingly, while for clarity the termiticide capsule 34 is shown located toward an edge of the chamber 3, in currently preferred forms it is preferable that the capsule is located generally centrally over the counter weight 4 where the tie 24 passes through.

It will of course be appreciated that in alternative configurations separate mechanisms can be used to trigger release of the termiticide and activate the detection signal. Furthermore, the signal circuit need not be limited to switching on an LED, but could also activate local or remote buzzers or markers or other indicators via low power wireless technologies such as Bluetooth®, ANT™, ZigBee® or other suitable systems as may currently exist or be developed in the future. Further, adjustments may need to be made to the configuration of the apparatus according to the signal system deployed. For example, if the cap is used to house a transducer to transmit radio waves for example, a line of sight orientation may be required, so the caps may be configured to slope in one direction accordingly. Further, the cap itself may be independently sealed to house and protect the batteries and associated mechanisms.

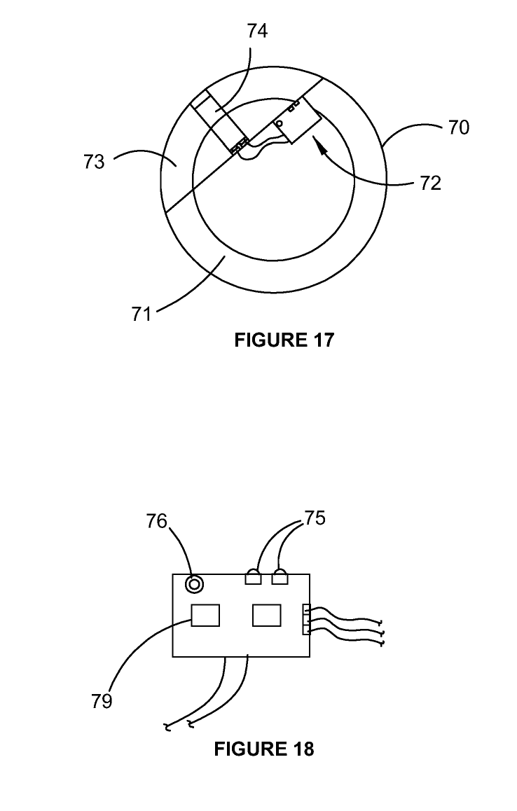

Further details of example lid configurations and control arrangements are described here after with reference to FIGS. 17 and 18.

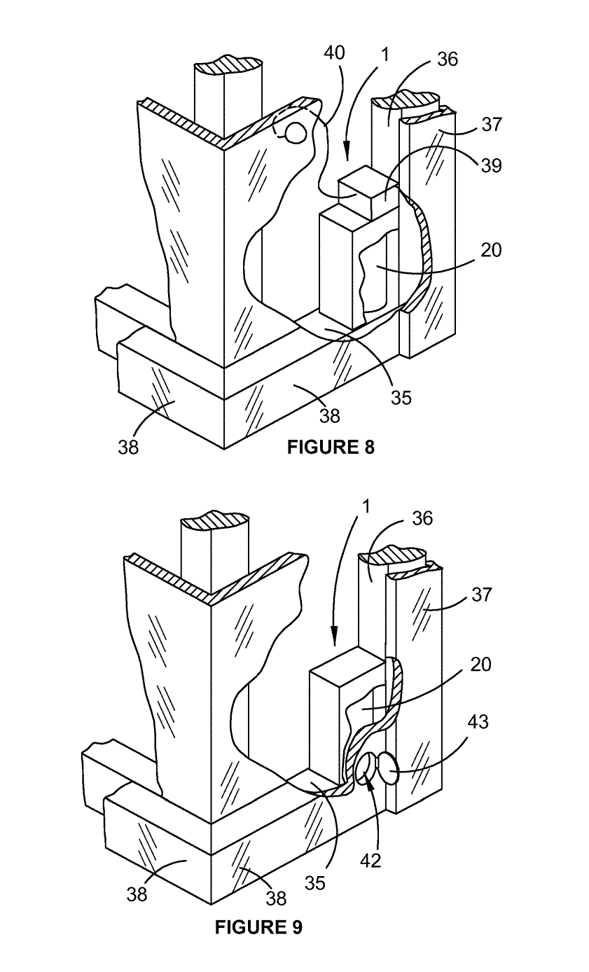

Turning next to FIG. 8 there is shown a partly sectioned perspective view of a wall section incorporating a third embodiment apparatus according to the second aspect configured for internal use. The device in this instance is positioned on top of bottom plate 35 up against a stud 36 adjacent the intersection with the door jamb and architrave 37 and skirting 38. Locations such as this which is where multiple layers of different timber types interface, are often favoured paths by termites.

The detection apparatus 1 is substantially the same as that shown in FIGS. 4-7 incorporating a counter weight 20 and attractant which is attached via a tie element to an electrical indicator system identified in general terms as item 39 which may be of a kind such as that exemplified in FIGS. 6 and 7. While the device could provide a wireless signal of an appropriate kind, in this particular example a physical lead 40 connects to a flashing LED disposed within the wall to protrude through the plasterboard or other cladding for easy viewing from within the room. In an alternative form, instead of having a visual indicator, the device could send an alarm signal to a buzzer or even send a message via text, email, internet, wireless device or other mechanism to a phone, tablet or computer, as required. An access panel may also be provided in the wall structure adjacent the device for servicing, installation and/or replacement and recharging with attractant, as may be required.

An alternative system that avoids the need for electronics of any kind is illustrated in FIG. 9. In this particular embodiment, a viewing portal 42 with openable window/lid formation 43 connects with an inspection chamber of the apparatus for manual visual inspection with a simple light or a special tool such as that shown in FIG. 2.

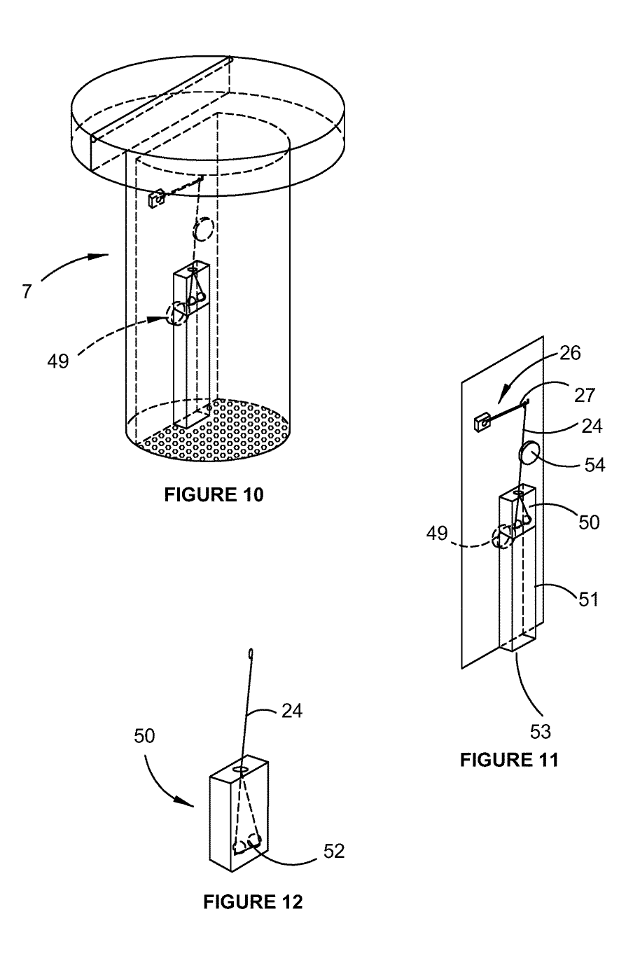

Turning next to FIGS. 10 to 12 there is shown a particularly preferred variation to the embodiment described in FIGS. 4 to 7. This further embodiment utilises the same principle of a tensile tie 24 holding down a trigger mechanism 26 biased into an activated state by a suitable biasing means such as a spring 27. However, in this instance, instead of holding the trigger in a deactivated position by applying a load to the tensile tie via a hanging counterweight, the tensile tie 24 is directly or indirectly restrained at one end by a part of the housing.

In the illustrated example, the restraint is by means of a plug 50 of readily consumable attractant similar to item 25 in FIGS. 4 and 5, which itself is constrained within the housing by any suitable means, which in this instance is via a plug tube 51. This tube is open at the lower end to allow the termites to enter, but shaped or otherwise configured with pins or the like to restrain the plug from moving upwards under the force of spring 27. The tie itself ideally has a loop or hook formation 52 which is embedded in the plug of attractant material 50 so that it is retained until the point that the attractant at that location is consumed and the connection is then compromised. Preferably, additional attractant is included within the housing, but the housing is ideally configured such that all the attractant can only be accessed via the opening 53 which leads to the attractant plug 50. This means that in this embodiment the attractant can only be accessed after the plug has been consumed and the trigger activated. In the example shown the base of the chamber which holds the bulk attractant has only small perforations which allow the termites to detect the attractant but not to enter directly into that part of the chamber.

Preferably, the plug 50 is located against a transparent observation window of the kind shown in the earlier embodiments. In this manner, the presence and progress of termites through the plug 50 is readily observed via the viewing chamber 7.

In the preferred form illustrated, an opening is also provided in the partition wall with a replaceable window 54. This enables addition of materials such as further bait or termiticide in to the first chamber where the attractant is, without the need to remove the main lid and more directly disturb the termites.

In some embodiments, a PIR (passive infra-red) sensor 49 is provided at or adjacent the attractant plug 50, preferably on the clean side of the plug tube 51 within the inspection chamber 7. This works as an adjunct to the trigger means in the main chamber that confirms the presence of termites before and after the trigger has been activated. PIR sensors of this kind could also be used in other embodiments as the primary detection means.

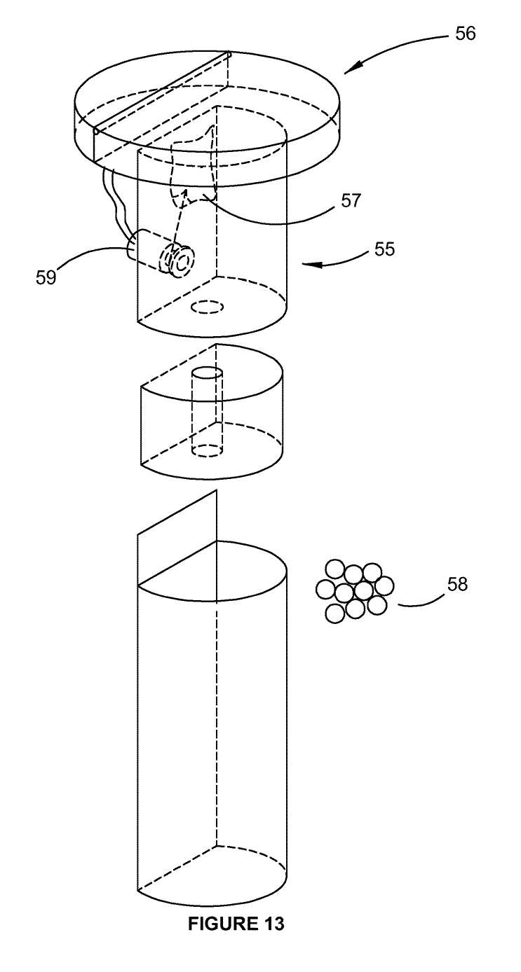

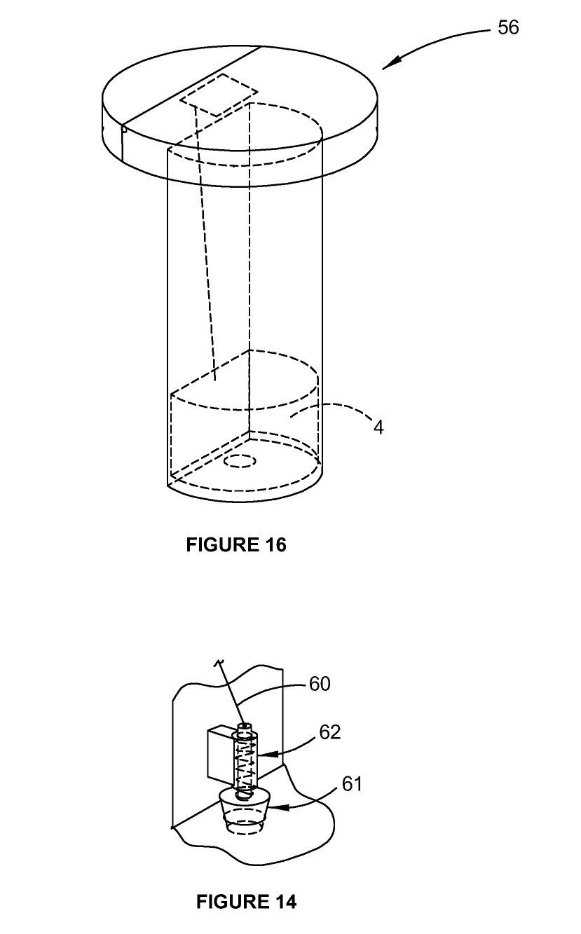

Moving next to FIGS. 13 and 14 there is shown another variation which includes a sealed tank portion 55 that is preferably part of the housing lid 56. The tank may include water for mixing with a satchel 57 of concentrated termiticide or flowable bait such as balls of bait 58. Connected with the tank is a motor 59, which is either water proof or positioned outside the tank, from which extends appropriate means to any of an impeller for mixing, and/or drive mechanisms to tear open the satchel 57 and/or open a gate from the tank or elsewhere to dispense the bait balls or mixed termiticide. An example of a gate mechanism operable via the motor 59 for opening the base of the tank 55 is shown in FIG. 14. In this embodiment a tie 60 is connected to a cog connected to the shaft of the motor 59 and operates to pull open the dome valve 61 against biasing spring 62. The cog mechanism can be any suitable arrangement and different functions could be achieved by reversing the motor direction as required. Alternatively, multiple motors could be used.

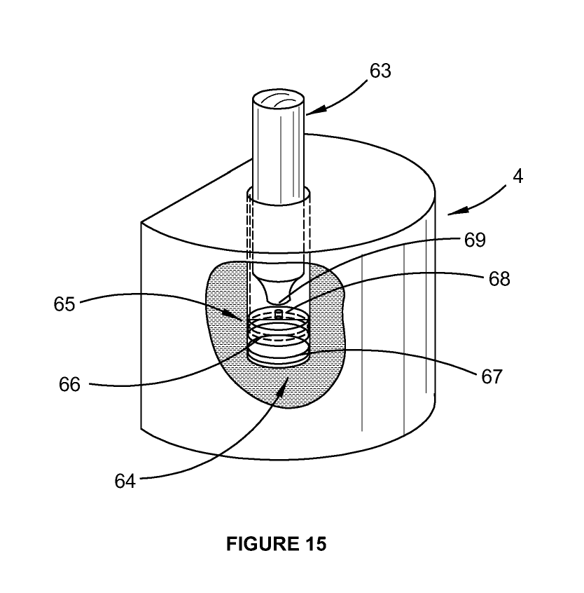

FIG. 15 shows an example of yet another way of delivering termiticide to the monitoring station in response to proven detection of termites within the housing. In this embodiment a cartridge 63 containing concentrated termiticide in liquid, gas or powder form is embedded in the attractant 4. When termites are present, a message can be sent either directly, or via a remote control system of the kind described here after, to activate the release mechanism shown generally at 64 to open the cartridge and release its contents.

The illustrated release mechanism 64 includes a spring 65 which is contracted into an activated position by means of it being wrapped by a heat sensitive string 66 which has a resistor 67 disposed beneath it. A firing pin 68 is provided between the end of the spring and a frangible end 69 on the cartridge such that when an electrified wire activates and heats the resistor 67, the heat burns through the heat sensitive string 66 so the spring is released and the tensile point 68 is driven into the frangible end of the cartridge to release the termiticide contents.

In one form the termiticide is in powder form and is flowable for release by gravity when the end 69 is pierced. In other embodiments the termiticide powder or liquid may be stored within the cartridge along with pressurised gas, such that on activation the gas drives the termiticide into the attractant.

FIG. 16 illustrates another form of detection based on weight variation. In this embodiment the attractant 4 is suspended from a weigh chip that is included in the system controls. The chip can be programmed to take action in response to predetermined variations in weight over time indicative of termite presence. A detailed example is as follows:

The attractant can be timber, other celullosic material or bait. In a preferred form the chamber is sealed at the base by the attractant's dimensions w. The termites can only enter the attractant by a small hole usually in the centre of its base so as to reduce the ingress of other pests and to reduce maintenance labour who would normally have to remove fauna that would stop the progress of termites into the monitoring station.

The attractant which is not in direct contact with the surrounding soil is weighed, for example, every 8 hours, and if the weight has not changed from the previous reading no message is sent to the central server. There is a need to keep messages to those that do not provide essential information. For two reasons a) it is redundant information b) there is also no reason to store redundant data on the central server, c) it uses battery energy to send a redundant message.

An initial increase in the weight can be caused by a number of circumstances:
insects attaching themselves to the bottom of the attractant,
Moisture absorption either by part emersion in ground water or from surrounding moisture.

An initial decrease in weight will normally be associated with termite feeding. There is however, other lower probability causes like removal of damaged wood by a variety of ants and bacteria and fungi. The later two may consume wood or timber but they generally replace it with their own weight. In general, well maintained wood does not have substantial eaters except termites.

After a period of time once termites reach the top of the attractant there is scope again for the attractants weight to increase as they build their mud trails to protect their environment. This can also be monitored by calculating the overall weight of the attractant plus any other structures or flora or fauna attached to it.

The rate of decrease in the weight of the attractant is considered a reasonably reliable indicator for the presence of termites.

A rapid increase in the weight of the attractant can also be a cause to investigate whether the attractant needs replacing. Water can damage wood and make it unpalatable or unattractive as a food source for termites. Such indicia supports a ability to remotely seek confirmation and so reduce the cost of maintaining termite monitoring stations.

The mechanism to weigh the attractant may comprise a weight chip like the MSP430F42x Single Chip Weigh Scale from Texas Instruments.

The chip with on-board strain gauge is suspended in a waterproof enclosure by a stainless steel wire whose other end it attached to the attractant. Readings and calculations are made by the on board micro control unit (MCU). They are then relayed by bluetooth communications chip to the line of site Communications hub. That hub converts bluetooth communication to the protocol and messaging standards of Wi-Fi™. These communications are directed via the premises Wi-Fi™ network at centralised severs connected on the internet. Should the premises not have Wi-Fi™ access then an appropriate communications channel will be installed. For example, a WCDMA or GSM modem or ethernet cable.

Locations that have low temperatures during winter and autumn (fall), the operation of weighing the attractant can be suspended until ambient temperatures reach 20 degrees celsius. To do this there is the ability to programme the MCU to not wake up until a certain time of the year approximating this temperature. This increases battery life reducing the cycle when batteries need to be replaced.

In further embodiments (not illustrated) release mechanism 64 includes other types of electrically controlled actuators positioned and configured to selectively release termiticide, including piezoelectric actuators, stepper motors, thermal or magnetically induced actuators and hydraulic actuators.

Referring next to FIGS. 17 and 18 there are shown schematic views of a possible layout of the control elements within a device. In this form, the control electronics are preferably housed in a removable lid element 70. The lid may define two chambers, a first 71 which is sealed and houses and protects the electronic circuitry 72 and other weather sensitive components, and the second 73 which may be openable to allow access to replace batteries 74 and the like.

The form and design of the circuit board will depend on the desired functionality. However, an example is shown in FIG. 18 which could be used to operate the embodiment shown in FIG. 13 which includes switches 75 indicative of lid various opening movements, switch 76 triggered by the detection mechanism in the housing, connections 77 to motor, connections 78 to batteries, and blue tooth device 79.

In all embodiments of all aspects, each device 1 preferably includes some form of unique identification marker shown generally in the Figures as item 45. This can take any suitable form including simple indicia like alphanumeric codes, bar codes or Q codes etc, or RFIDs, or indeed any means of applying a preferably unique identification, that for the more complex systems can ideally be read automatically using an appropriate visual or non visual scanning or reading device.

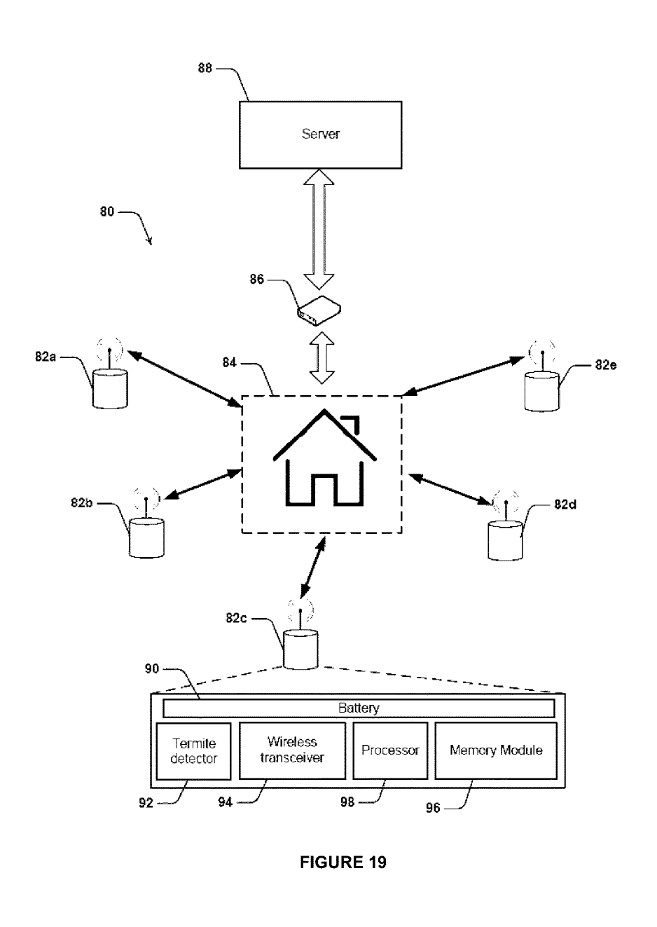

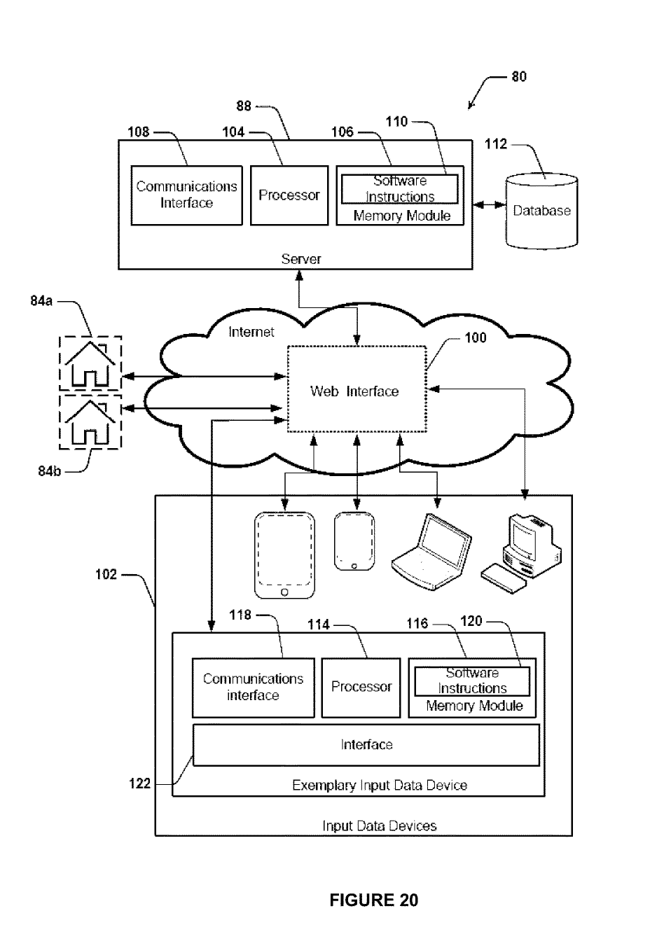

Preferably, these markers are used in accordance with a third aspect of the invention which provides systems and associated methods for facilitating pest monitoring, pest control, and recording and certifying adhesion to a pest control protocol for a particular installation. An exemplary system 80 is illustrated in FIGS. 19 and 20.

Referring initially to FIG. 19, such a system is based on the steps of firstly installing a plurality of termite monitoring stations 82a to 82e, preferably, but not essentially, in the form of stations in accordance with various aspects of the invention as described herein, with each station having a unique identification marker. In particular, although system 80 will be described with specific reference to the detection, monitoring and control of termites, it will be appreciated that system 80 could be used in the detection, monitoring and control of other types of pests provided the stations 82 are adapted for detecting those pests. In some embodiments, different subsets of stations 82 may be directed to detecting different types of pests.

Stations 82 are installed at known locations around a designated property and each communicates wirelessly with a central hub 84 which, in turn, is in wired or wireless communication with a network device such as a modem 86 to communicate data to a remote server 88. In an exemplary embodiment, central hub 84 includes two wireless transceiver modules situated at different locations within a house or building that is located on or adjacent to the property being monitored for pests. In some embodiments, two or more remote servers are utilised for redundancy when one server may be offline or unavailable.

As illustrated in FIG. 19, the basic requirements of each station 82 include a power source in the form of a battery 90, an electronic termite detection means 92 for detecting the presence of termites (or other pests) and generating a detection signal, and a wireless transceiver 94 for wirelessly transmitting the detection signal to a central hub 84. Each station 82 also includes a memory module 96 for local storage of data and signal buffering and a processor 98 for performing various local functions such as signal encoding. In embodiments where stations also receive data and/or instructions from hub 84, processor 98 and memory module 96 perform advanced functions such as decoding and buffering of the incoming wireless signal. The various electronic components are preferably mounted on a substrate (not shown) such as an integrated circuit and contained in a protective housing.

In some embodiments the stations include additional hardware such as:
Battery change level sensor;
Temperature sensors to monitor the conditions of each station;
Attractant mass sensor;
Vibration sensors;
Passive IR sensors; and
Cameras for capturing pictures of the chamber upon detection of termites.

Communication between stations 82 and hub 84 is performed by one or more low power wireless communication protocols such as Bluetooth™ Bluetooth Smart™ (Bluetooth low energy). As each station is battery operated, power conservation is important. Accordingly, in preferred embodiments each station is maintained in a low power or sleep state until a trigger activates the station into an active state. Such triggers may be the detection of termite by a termite detector (detection means 92), an external instruction signal from hub 84 or the expiration of a predetermined time period.

Communication between hub 84 and modem 86 can be performed through a wired network connection such as Ethernet or by one or more wireless communication protocols such as Wi-Fi™. In some embodiments, hub 84 is fitted with a GSM or other mobile network protocols and is able to bypass modem 86 to communicate wirelessly with server 88. In various embodiments, server 88 is accessed through the internet, local area network or other network protocols.

Referring now to FIG. 20, there is illustrated schematically a broader system level overview of system 80 showing how various interested parties connect through a centralised web interface 100. Interested parties typically include an owner or administrator of the overall system, pest control managers such as pest control businesses and system participants such as property owners or property managers. In some embodiments, a pest manager and a system owner may be the same entity. System 80 allows the communication of data between these parties to provide a comprehensive pest management service.

Web interface 100 is accessed by the parties by way of client terminals 102. In overview, users access interface 100 over the Internet by way of client terminals 102, which in various embodiments include the likes of personal computers, tablet computers, PDAs, cellular telephones such as Smartphones, gaming consoles, and other Internet enabled devices.

Server 88 includes a processor 104 coupled to a memory module 106 and a communications interface 108, such as an Internet connection, modem, Ethernet port, wireless network card, serial port, or the like. In other embodiments distributed resources are used. For example, in one embodiment server 88 includes a plurality of distributed servers having respective storage, processing and communications resources. Memory module 106 includes software instructions 110, which are executable on processor 104.

Server 88 is coupled to a database 112. In further embodiments the database leverages memory module 106.

In some embodiments web interface 100 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

In addition to use of a website/browser-based implementation, interface 100 also includes a mobile compatible version that is particularly adapted for use with mobile devices utilising proprietary software (Apps). For example, client terminals such as Smartphones include software instructions for a computer program product that essentially provides access to a portal version of interface 100 via which server 88 is accessed (for instance via an iPhone app or the like).

In general terms, each terminal 102 includes a processor 114 coupled to a memory module 116 and a communications interface 118, such as an internet connection, modem, Ethernet port, serial port, or the like. Memory module 116 includes software instructions 120, which are executable on processor 114. These software instructions allow terminal 102 to execute a software application, such as a proprietary application or web browser application and thereby render on-screen a user interface and allow communication with server 88. Each terminal 102 also includes an interface 122 such as a touchscreen interface for presenting information to a user and allowing input from the user. This user interface allows for the creation, viewing and administration of profiles, access to the internal communications interface, and various other functionalities.

Hubs (e.g. 84a and 84b) from various properties are also able to be accessed through interface 100 by the system owner and optionally by the other parties. The various parties will have different levels of access to server and the hubs with the system owner having the highest level of access. Access levels to pest managers and system participants may be provided on a paid subscription basis with greater functionality and visibility being available at a higher subscription fee (paid monthly, yearly or the like).

In an alternative embodiment (not illustrated), system 80 includes no central hub and the individual monitoring stations 82 communicate directly with server 88 through a wireless communication such as mobile GSM protocols or even through a wired network. These embodiments would inherently have higher power usage so high capacity batteries and power management would be even more important.

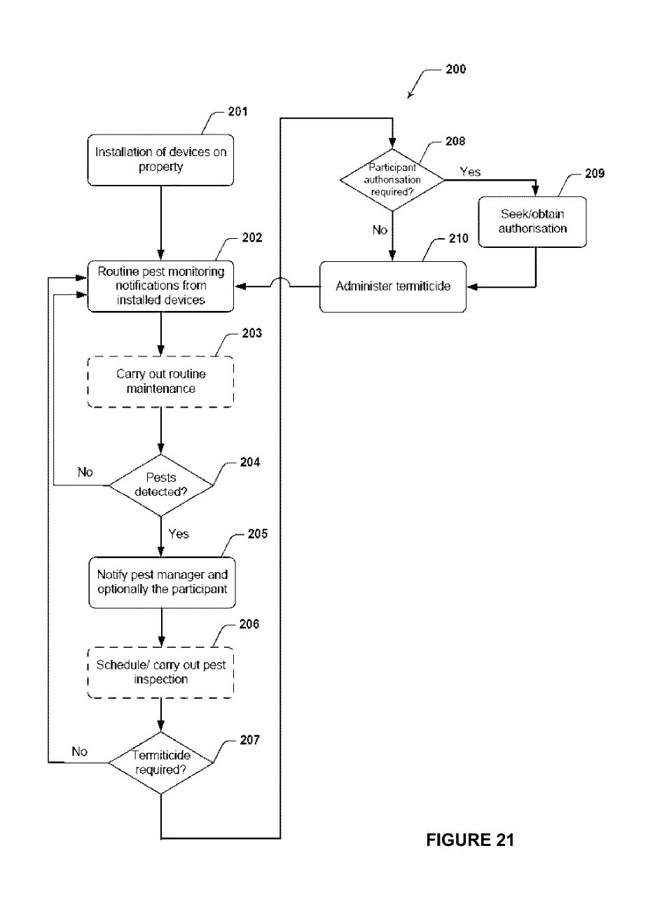

In a first embodiment of the third aspect, the system framework described above and illustrated in FIGS. 19 and 20 provide for implementing a system and associated method of facilitating pest monitoring and control. Referring to FIG. 21 there is illustrated a process flow diagram illustrating the primary steps in an exemplary method 200 of facilitating pest monitoring and control. Dashed boxes in the drawing indicate optional steps in the procedure.

At step 201 pest monitoring stations, such as those described above, are installed on a property to be monitored. Installation is typically performed by a professional installer or a trained pest control professional but the stations may be installed by the untrained property owner/manager under suitable instruction. The installation process includes the installing of the central hub on or adjacent a house or building on the property and within wireless communication range of the installed monitoring stations.

Data from the completed installation is recorded in database 112 with individual records for each separately identifiable station. This database could be administered by the station manufacturer, or a pest control company, or even an unrelated third party acting as a certifying body. Depending on the sophistication of the stations installed, key data recorded would include things like date of installation, location of the property (including boundaries) and individual installed stations, dates of replacement of consumables and dates of application of termiticide, dates of detection of termites and changes in detection status etc.

The data from the installation is allocated or added to a specific user account for the system participant and a pest control manager is associated with the account. To access the account, the participant is able to download a suitable computer program in the form of a mobile proprietary software based App or similar onto mobile devices and enters relevant account login details. Similarly, the participant can access their user account through a web browser by accessing a specific website and entering relevant account login details. In either case, the user is provided with access to server 88 and database 112 through web interface 100. Access to the user account by the participant is contingent upon the participant paying the system owner/administrator a subscription fee on a monthly, yearly or other agreed upon timeframe.

Pest control managers have their own accounts which are linked to associated user accounts for properties in which they are contracted to monitor. Access to the pest control manager accounts is also performed by a mobile App or through a specific website.

At step 202, once installed, the monitoring stations are configured to issue routine pest monitoring notifications including the detection of termites, station battery level, attractant amount remaining, termiticide amount remaining and optionally other internal station conditions. The notifications are sent to server 88, stored in database 112 and are typically only received by the system owner/administrator. However, depending on the particular configuration of the system and user account, these notifications may be sent directly to the participant and/or pest control manager in addition to the system owner/administrator.

In response to the notifications received from the monitoring stations, server 88 is configured to generate a specified program of reminders and notifications regarding inspections, battery replacements, attractant replacements, electronic signalling equipment testing etc. The program will then operate to notify the key stakeholder, which, depending on the nature of the reminder, may be the system participant, pest control company, system owner/administrator or another party, when actions need to be taken regarding inspections, battery and attractant replacements etc. The number, type and frequency of reminders and notifications is established through settings associated with the user account. Depending on the type of user subscription, the participant may have authority to change one or more of the number, type or frequency of the reminders and notifications. Some changes may only be made by the system owner/administrator.

In the event of a reminder being triggered to carry out routine maintenance of a monitoring station, at optional step 203 the pest control manager or participant is prompted to carry out the maintenance. Such maintenance may be, for example, to replace a battery, replace attractant or install or replace termiticide.

At decision 204, if during routine monitoring the installed stations detect no termites, the monitoring continues and the procedure returns to step 202. If, however, termites are detected (say, by the triggering of a main switch within the device), at step 205, a notification is sent to the pest manager and optionally to the participant. The notification is also stored in database 112 and logged as an event in the participant's account. The detection of termites is recorded as a detection event and the location and time of the detection is stored in database 112 for subsequent historical analysis and planning. Optionally, at step 206, a pest control person may be prompted to carry out a personal pest inspection of the property.

Next, decision 207 is made whether to administer termiticide. This decision may be based on a professional opinion by the pest control manager. If the decision is to not administer termiticide, the process returns to step 202 and normal pest monitoring continues. If the decision is to administer termiticide the pest control manager updates a field to provide their response. A further decision 208 is made as to whether participant authorisation is required. If the participant has been requested to be notified to consent to the administering of termiticide on their property, at step 209 the appropriate authorisation is sought. This can be obtained through electronic means such as an electronic notification and request for consent or through more manual means such as a text message or email to the participant, a phone call or even a personal visit. The participant is able to provide their consent electronically through the web interface.

Once authorisation is provided, or if no authorisation is needed, at step 210 the termiticide is administered through one or more stations or otherwise in an attempt to eradicate the termites. The termiticide may be applied manually by the pest control manager or may occur automatically through the issuance of an instruction to an actuator within the monitoring station such as in the embodiments described in FIGS. 13 and 14.

After administering of the termiticide, the procedure returns to step 202 and normal monitoring resumes. In some embodiments, the frequency of monitoring by one or more of the stations may increase after initial detection of termites.

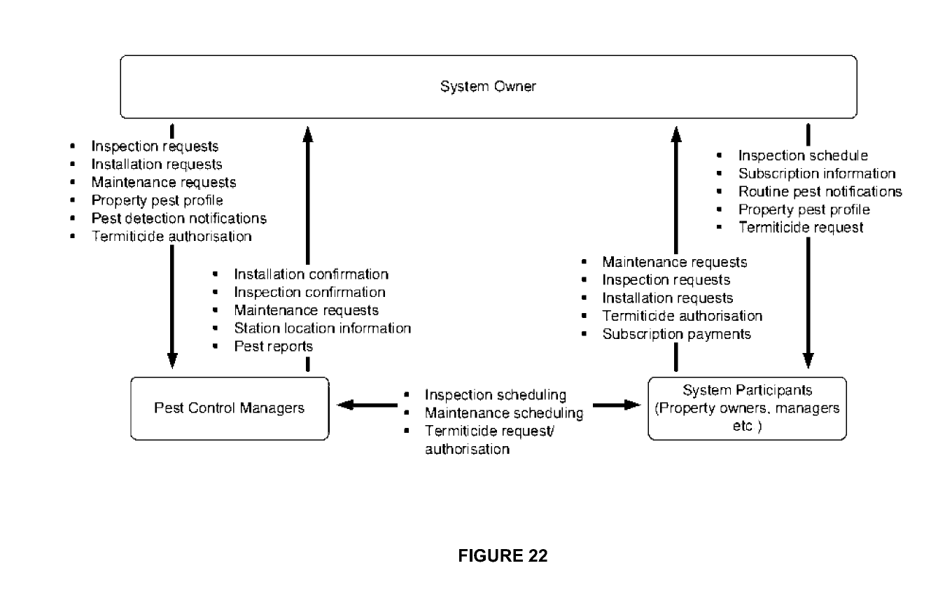

As such, by implementing the above method, the system provides comprehensive automated pest monitoring system. FIG. 22 illustrates schematically exemplary information flow that occurs between the various parties using the system.

As system 80 allows for the recording of termite detections events, the stored data can be used to generate a termite profile of the property indicating statistics such as historical termite attack locations and frequencies. These profiles may be generated automatically or upon request by an interested party such as the property owner. Furthermore, if a number of nearby properties have monitoring systems installed, the system owner/administrator is able to combine the data from multiple installations to generate a larger scale termite profile. This data could have significant economic value in terms of promoting the need for termite control in a particular area, property valuations, land prices and future town planning etc.

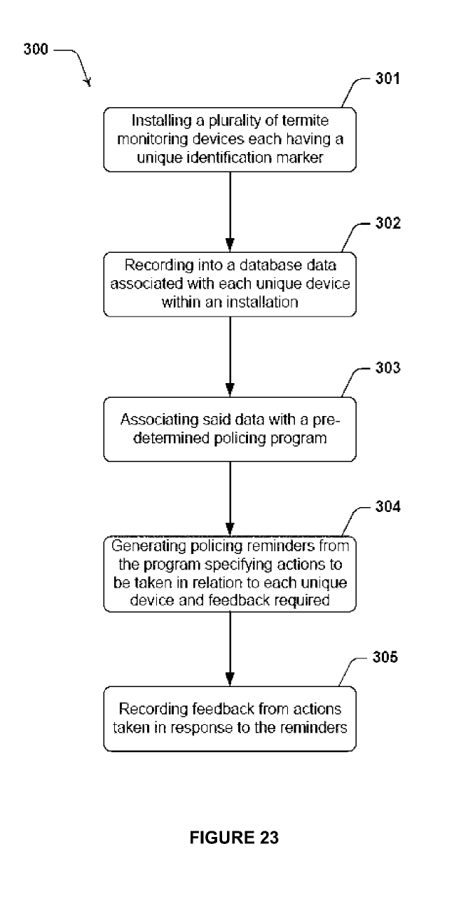

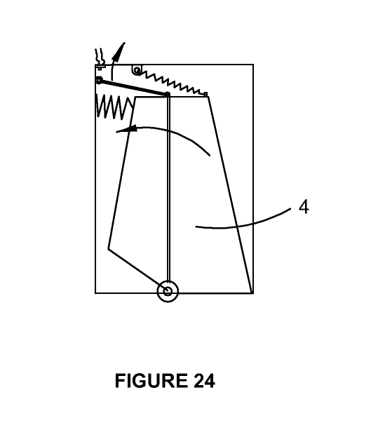

In a second embodiment of the third aspect, the system framework described above and illustrated in FIGS. 19 and 20 provide for implementing a system and associated method of recording and certifying adhesion to a pest control protocol for a particular installation. Referring to FIG. 23, there is illustrated a process flow diagram outlining the primary steps in a method 300 of recording and certifying adhesion to a pest control protocol.

At step 301 a plurality of termite monitoring stations are installed, each having a unique identification marker. The installation procedure is preferably performed in a manner similar to that described above. At step 302 data associated with each unique station within the installation is recorded into database 112. At step 303 the data is associated with a pre-determined policing program also stored in database 112. At step 304 server 88 generates policing reminders from the program which specify actions to be taken by the various parties in relation to each unique station and the feedback required. The reminders are sent via interface 100 and are retrievable on the various electronic client terminals though a web page or mobile software App. Finally, at step 305 feedback from actions taken by the parties in response to the reminders is recorded in database 112.

Ideally, means will also be provided for the person responsible for adherence to the agreed monitoring protocol, to feedback appropriate update information regarding each of the stations within the installation.

The system may further include means within, or separate to, the policing program, to compare the recorded feedback against a pre-set protocol of actions and outcomes and generate a report of compliance with or against the protocol.

Depending on the types of monitoring stations used, the system may record date of installation, replacement of attractant and/or batteries within set time frames, inspection frequency, proof of inspection including date of inspection, outcome of inspection, date of application of termiticide, etc.

The transfer of data to and from database 112, and to and from server 88 may be configured to utilise existing and future capabilities of fixed or mobile devices such as smart phones and the like.

An example illustrating the kind of information that could be monitored, the monitoring protocol and the optional use of internet based servers is set out below.

Each communication (data packet sent) from a monitoring station may have the following content of data:
a unique address of each station (normally the MAC address of the Bluetooth based motherboard);
battery status current battery capacity and voltage;
date and time compromised by termites (main switch pressed);
date and time last accepted transmission;
date and time inspection lid lifted (hub shows red light) (also used for initial install to check connectivity with hub);
date/time inspection lid lowered;
date/time main chamber lid lifted; and
date/time main chamber lid lowered.

In an exemplary embodiment, the maximum packet size of the above data excluding protocol data is approximately 150 Bytes.

To preserve battery life, processor 96 remains in a low power ‘sleep state’ and waits to send the information which is sent at preferred times such as:
When other data is required to be sent from the station, such as when the main switch is engaged to indicate the presence of termites;
Monthly, at a predetermined time; and
When the observation lid is lowered before sending off data. (The first data received indicates the installation date).

When data is not able to be sent the data is stored in memory module 96 of hub 84. When sending messages the hub checks whether there are any previous messages that haven't been sent and forwards these as well.

In one embodiment, each data packet is preferably sent to two different servers with different internet protocol addresses. This is to cater for the prospect of one of the servers being unavailable for any reason. When one of the servers is not able to be reached then the server who has accepted this data packet is notified of this event.

When main switch in any monitoring station is activated, also turn on flashing LED on lid of monitoring station. Indicates visually when termites are present.

When the observation lid is lifted the monitoring hub also has an associated LED blink 3 times (used to confirm connectivity to monitoring station).

Using a central internet based server as described above provides the following functionality.

A) Determining failure of any component of the system:
If the required monthly messages are not received from a location to the central server;
If not all monitoring stations (at a particular property location) have reported during that monthly monitoring period; or
If not all the lids are lifted during an inspection then a report will be sent to the designated Inspector upon enquiry (normally before leaving a site) of those monitoring stations that have not been lifted.

B) The central Server 88 receives input from a participant's computer or mobile device. This input can be messages detailing any activity that cannot be automatically recorded by each monitoring station, such as:
Release termiticide or bait;
Replace battery;
Replace attractant;
Add bait or termiticide;
Clean monitoring station;
Replace lid;
Replace internal container;
Replace monitoring station itself; or
Lodge a status of completion of work at a location.

These messages are sent by mobile application directly to the central server.

C) Messages are sent to designated participants from the central server based on, for example, the following:
Main switch of a monitoring station is engaged (indicating the presence of termites) for a particular monitoring station;
A photograph or video lodged to the central server by an inspector that is to be passed to all interested parties;
A visit report is prepared and sent by the central server at completion of a visit by an inspector;
The release of termiticide or bait instruction has been effected for a particular monitoring station.

Systems according to the invention can be further enhanced to include and enable localised Wi-Fi™ network extension and security monitoring with security cameras, at minimal additional costs.

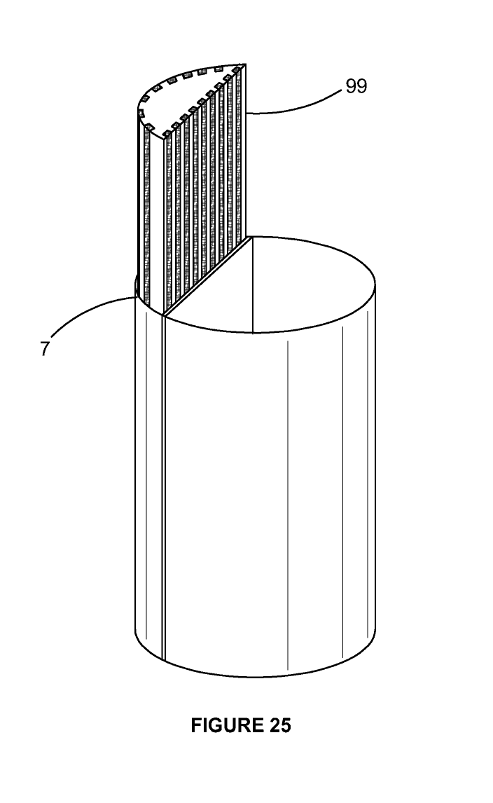

Termiticide loaded bait elements may also be added to any embodiment of the system as needed. In one form, bait sticks specifically configured for sliding into the inspection chamber via the top inspection lid opening have been proposed. Ideally these bait sticks have longitudinally extending flutes or corrugations to maximise surface area for a given volume to maximise termiticide transfer to the termites. Preferably the flutes are sized to provide pathways for the termites to/from a portion of the bait stick. An example of a suitable bait stick 99 configured for use in the inspection chamber 7 is shown in FIG. 25.

In another embodiment (not illustrated) advantage can be taken of a termite fear reaction where the termites hit their bodies against other objects when they are in fear or are reacting to noise or vibration events. This creates a noticeable noise that can be successfully recorded by a microphone. Their reaction to the noise and vibration is almost instantaneous. Simulating this vibration by using a vibration motor and concurrently a mid pitched sound recorded from previously tested successful reactions from termites creates the availability of the almost certain and natural termite reaction. The computer initiating the vibration motor and the loud speaker at the same time turns on the microphone to see if a reaction from termites is forthcoming. This recorded noise in the same frequency range a normal termite reactions indicates the presence of termites. Such positive reaction is then forwarded to the messaging system previously detailed above to report that termites have a high probability of being present in this particular monitoring station.

In yet another range of embodiments, the presence of the termites can be triggered by movement of an element within the housing from an inherently unstable position to a stable position by action of the termites.

In one form, the bulk attractant may be configured to rest on a pivot point where the attractant is initially held in an inactivated position by weight balance, or assisted by light springs etc. The weight and shape can be configured such that the termites are directed to a particular region of the attractant, whereby once the weight of the attractant is reduced at that location, the balance is upset and the attractant tips to the stable position, at the same time activating some form of switch or alarm triggered directly or indirectly by the movement of the attractant mass or elements connected thereto.

One possible configuration is illustrated in FIG. 25. The principle in this embodiment is that as the attractant reduces in weight a spring attached under tension to the heavier side of the attractant gradually moves to an equilibrium point. The spring is attached at the top of the chamber. The bottom of the attractant may have plastic attached so that termites can only enter at a predetermined point on the heavy side such as via an 8 mm hole. Any movement at the top of the attractant is magnified such that a protrusion or a longitudinal piece of plastic attached on the top of the attractant (near the point of attachment of the spring) makes contact with a switch. The attractant may be sloped up ways from the bottom so that a pivot point is created, or secured to a pivot mechanism. The pivot point is not seen by the termites as the plastic base looks to be entirely flat from underneath. But there is then room to be able to pivot. Also to create the weight differential of the attractant on the top the attractant has a wedge cut out of it, where the attractant will naturally fall when the attractant become lighter. A further light spring holds the attractant at the top left as shown so that the attractant doesn't initially move.

In another variation (not illustrated), the unstable bulk attractant may be held in the initial inactivated position by a plug of preferentially enticing attractant which acts as a compromise point, such that once this bracing element is consumed it ceases to support the mass attractant which then tips to the stable position as above.

In both these embodiments the switch is activated by the moving weight, as opposed to the earlier embodiments where the switch is biased into an activated position and then held away from that position until the tension against the biasing means is removed, either by the counter weight being released or the anchor being released.

It will be appreciated that the first aspect of the invention provides considerable advantages over the prior art in terms of being better able to visually detect the presence of termites in the stations by providing a debris free inspection chamber, and facilitate that visual inspection without disturbing the atmospheric conditions in the chamber in which the attractant is present. This significantly enhances the likelihood of the termites establishing a feeding pattern at a station prior to termiticide being added, which further increases the likelihood of effective eradication of the colony.

It will also be understood that the second aspect of the invention provides means for automatically detecting the likely presence of termites without external interference in a manner that again is unlikely to frighten the termites away from the food source, such that a feeding pattern once again is more likely to be established and maintained, increasing the chances of effective post detection treatment and eradication. Furthermore, the design of the apparatus can be fine tuned to adjust the likely point of frangibility of the tie element to try to control how much time is allowed in establishing a feeding pattern prior to setting the alarm and/or activating or applying the termiticide.

It will also be understood that any reference to specific means of control and communication is not intended to be limiting, and that the advantages of the invention can be achieved using other control and monitoring media including those yet to be developed.

In addition, while the preferred embodiments are described as being made from polymeric materials, various forms of the embodiments of the inventive aspects could be made from one or more suitable materials including timber and could be made is a range of shapes other than those described.

Further, various enhancements to both aspects, coupled with the proposed systems and methods of the third aspect of the invention, readily enables compliance with, and recording of compliance with, predetermined pest monitoring and control protocols. This in turn can provide improved assurance to home buyers and home owners of residences where the system has been implemented, and enhance the value proposition of services offered by pest control companies.

Finally, it will be appreciated that while reference has been made to specific examples, numerous variations can be made, and any suitable features of one embodiment may be combined with some or all of the features of another embodiment, all without departing from the general scope of each aspect of the invention.

The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

In various embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while the diagrams only show a single processor and a single memory that carries the computer-readable code, those in the art will understand that many of the components described above are included, but not explicitly shown or described in order not to obscure the inventive aspect. For example, while only a single server is illustrated, the term “server” shall also be taken to include any collection of server machines that individually or jointly execute a set (or multiple sets) of instructions to perform any one or more of the methodologies discussed herein.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the description are hereby expressly incorporated into this description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Similarly, it is to be noticed that the term coupled, when used in the claims or description, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A termite detection apparatus including a housing defining:
a first chamber for receiving a first bulk portion of termite attractant and a second smaller portion of attractant;
a small movement trigger and a first switch operable by the trigger, the trigger including means to bias it into an activated position whereby it operates the first switch;
anchor means disposed within the second smaller portion of attractant and connected with the trigger via a tensile tie to hold the trigger against the biasing force into a deactivated position;
at least one gate opening via which termites can enter and leave the housing to initially access only the second portion of attractant;
wherein the materials of the second attractant are selected so as to be consumed in the presence of termites to cause disconnection of the tensile tie between the anchor means in the second portion of attractant and the trigger to thereby operate the switch while facilitating ongoing consumption of the first bulk portion of attractant.

2. A termite detection apparatus according to claim 1 wherein the second portion of attractant is manufactured from a mouldable particulate matter as a plug element into which the anchor means is embedded.

3. (canceled)

4. The termite detection apparatus according to claim 1 wherein the second portion of attractant is formed as a separate plug that is secured to the first chamber and the gate opening leads to this separate plug.

5. The termite detection apparatus according to claim 1 wherein the housing includes a second inspection chamber co-extending at least in part with the first chamber, the second chamber including an openable second chamber lid and generally inperforate walls, wherein at least one wall portion of the second chamber is defined by a transparent section of a wall common with the first chamber to provide a viewing window.

6. (canceled)

7. The termite detection apparatus according to claim 1 including a power source and means associated with the switch to provide a detection signal.

8. The termite detection apparatus according to claim 7 including a wireless transceiver.

9. The termite detection apparatus according to claim 8 including a processor for performing various local functions including at least one of outgoing and incoming signal encoding and decoding or buffering of incoming wireless signals.

10. The termite detection apparatus according to claim 8 or claim 9 including a local memory module.

11.-12. (canceled)

13. The termite detection apparatus according to claim 1 further including means to store bait or termiticide and release this into the first chamber when, or at a predetermined time after, termites have been detected and the first switch actuated.

14. The termite detection apparatus according to claim 13 wherein bait is stored in or adjacent the first chamber in a pelletised flowable form and and means are provided to release this remotely on demand into the first chamber.

15. The termite detection apparatus according to claim 13 including water storage means, termiticide concentrate and means to mix the water and concentrate on demand and deliver into the first chamber.

16. (canceled)

17. The termite detection apparatus according to claim 1 including a unique identification marker.

18. (canceled)

19. The termite detection system including a plurality of termite detection apparatuses according to claim 1, each apparatus including a unique electronic marker, a power source, a first switch and means associated with the switch to provide a detection signal, and a wireless communication means to issue alerts to an external device.

20. The termite detection system according to claim 19 wherein the external device includes at least one local hub for receiving wireless transmissions from each apparatus and issuing alerts to one or more other external devices or parties.

21. The termite detection system according to claim 19 wherein the wireless communication means is performed by a low power wireless communication protocol.

22. The termite detection system according to claim 19 further including a network device including a modem to communicate data from the hub to a remote server.

23. The termite detection system according to claim 19 wherein the hub is fitted with mobile network protocols to communicate with a remote server.

24. The termite detection system according to claim 19 wherein the central hub includes two or more wireless transceiver modules for situation at different locations on a property to optimise reception.

25. The termite detection system according to claim 19 wherein the hub communicates with external parties by way of a web server and associated web-based interface.

26.-32. (canceled)
